(19) United States
(12) Patent Application Publication
(10) Pub. No.: US 2013/0101968 A1
(43) Pub. Date: Apr. 25, 2013

(54) HEAVY EQUIPMENT SIMULATOR AND RELATED METHODS

(71) Applicant: CSE Software Inc., Peoria, IL (US)

(72) Inventors: Andy S. GRABENSTETTER, East Peoria, IL (US); Brandon M. REYNOLDS, Washington, IL (US); Jade S. SKAGGS, East Peoria, IL (US)

(73) Assignee: CSE SOFTWARE INC., PEORIA, IL (US)

(21) Appl. No.: 13/648,935

(22) Filed: Oct. 10, 2012

Related U.S. Application Data
(60) Provisional application No. 61/545,571, filed on Oct. 10, 2011.

(51) Int. Cl. G09B 5/02

(52) U.S. Cl. CPC G09B 5/02
USPC 434/63

(57) ABSTRACT

A method for training an operator of a machine including interacting with a simulation mode of a heavy equipment model simulator and evaluating an operator using criteria substantially similar to an original equipment manufacturer (OEM) criteria for a non-simulated heavy equipment model. Interacting includes performing one or more simulated exercises substantially similar to an OEM exercise for the non-simulated heavy equipment model.

### RELATED APPLICATION

This application claims priority under 35 U.S.C. §119(e) to U.S. Provisional Patent Application No. 61/545,571, filed Oct. 10, 2011, which is incorporated herein by reference in its entirety.

### BACKGROUND

Machines such as excavators, wheel loaders, track-type tractors, motor graders, large vehicles, dozers, and other types of heavy equipment are used to perform a variety of tasks associated with industries such as mining, farming, construction and transportation, for example. Operators of these machines may be required to receive a significant amount of training prior to operating these machines on-site. In some cases, machine operators must be licensed and certified by a certification board or governing body to operate certain equipment or vehicles to ensure that the operator has received the appropriate training.

Machine operators are generally trained in computer-based simulators and in training exercises prior to performing actual work-related operations. While these methods may provide a basic level of operational exposure, they may not provide an environment that completely prepares the operator for actual “real-world” work experiences associated with a job site. Thus, many inexperienced machine operators may require additional on-the-job training in certain areas associated with machine operation using costly fuel and manpower. Further, many experienced machine operators may require supplemental training for certain operational skills and/or new techniques associated with one or more machines. Such tasks add to the expense and time associated with completing business objectives.

Current simulation systems for heavy equipment are simplistic in displaying the simulated environment as well as in calculating and displaying how the simulated machine interacts with the environment. In addition, teaching and instructor interaction is limited.

### BRIEF DESCRIPTION OF DRAWINGS

FIG. 1 shows a block flow diagram of a method of training an operator of a machine, according to some embodiments.

FIG. 2 shows a block flow diagram of a method of simulating terrain, according to some embodiments.

FIG. 3 shows a block flow diagram of a method of simulating a physical interaction in a simulator, according to some embodiments.

FIG. 4 shows a block flow diagram of a method of training an operator, according to some embodiments.

FIG. 5 shows a schematic view of a representation of machine in the example form of a computer system, according to some embodiments.

### SUMMARY

Embodiments relate to a method for training an operator of a machine including interacting with a simulation mode of a heavy equipment model simulator and evaluating an operator using criteria substantially similar to an original equipment manufacturer (OEM) criteria for a non-simulated heavy equipment model. Interacting includes performing one or more simulated exercises substantially similar to an OEM exercise for the non-simulated heavy equipment model.

Methods also include a method of simulating a physical interaction in a simulator. The method includes identifying simulated physical contact zones between two or more simulated objects and defining one or more interactions in the contact zones separate from simulated environmental or equipment object rules.

Embodiments relate to a machine-readable medium comprising instructions, which when implemented by one or more processors perform the following operations: initiating an instruction module, initiating a simulation module for controlling a machine, selecting an instruction mode, interacting with a simulation mode, compiling results, transferring results to instruction module and outputting results.

### DETAILED DESCRIPTION

Embodiments of the present invention provide hardware and software solutions to enhance a heavy equipment simulation experience for a user in a way that more closely merges the simulation with actual work operations. Additionally, the embodiments of the present invention describe unique instructor control, instruction modules and student or user feedback systems.

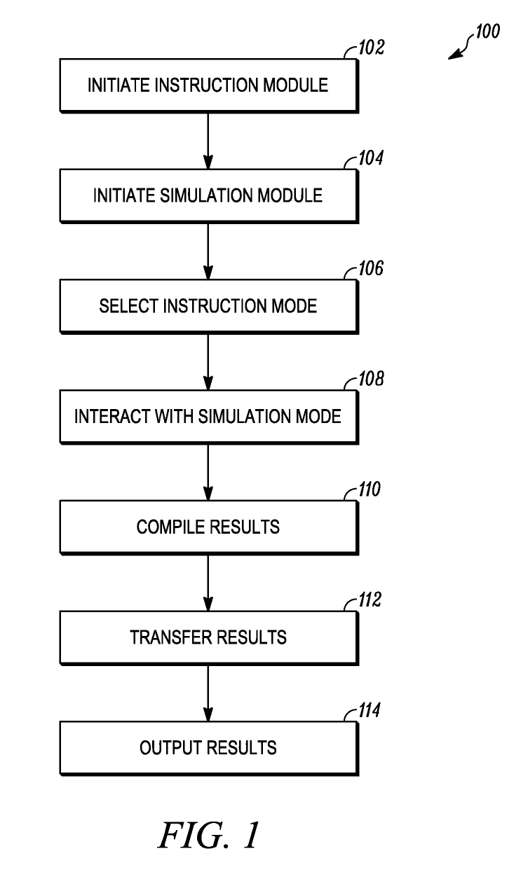

Referring to FIG. 1, a block flow diagram 100 of a method of training an operator is shown, according to some embodiments. An instruction module is optionally initiated 102 by an operator (i.e., student or user) or an instructor. A simulation module 104 is then optionally initiated 104. One or more instruction modes are optionally selected 106. The operator interacts 108 with one or more simulation modes of a heavy equipment or machine simulator. The operator is evaluated using criteria substantially similar to an original equipment manufacturer (OEM) criteria for a non-simulated heavy equipment model. The results are then optionally compiled 110 and optionally transferred 112 to the instruction module. The results are then optionally output 114 as a visual display, print out or both.

Initiating a module 102 can be performed by an instructor or operator. The simulator allows for an instructor to build a custom exercise program. The program can simulate equipment failure and incident response, for example. In the instruction module, the instructor can select safety procedures, operational exercises and operational and equipment parameters (e.g., engine speed). The instructor can be near the simulator or interacting with the instruction module remotely, such as through a remote input device. Examples of remote input devices include cell phone, tablet computer, laptop computer or personal digital assistant (PDA).

Initiating the simulation module 104 can be done remotely or at the simulator. The one or more instruction modes can be selected 106 by either the instructor or student. Instruction modes include at least a practice mode and exam/assessment mode or operational mode. The practice mode includes help functionality not present in the assessment mode. One example of the help mode includes a graphical control icon that appears on the display after a set time has elapsed without completing an exercise goal. The help mode may include instruction feed text on the display, such as on the bottom of the display. The practice mode optionally does not score a user, but can be graded against the exam mode criteria.

If in exam mode or scored in practice mode, results are compiled 110 either at the simulator or remotely (e.g., wirelessly transmitted to a remote device or computer). In the assessment mode, there may be section instructions to assist with the flow of the exercise. These can be displayed across a portion of a display screen. The instruction module accepts one or more parameters to indicate what exercise to start, what map to start, whether to start in practice mode or assessment mode, and various other parameters set through instruction module by an instructor or user.

The operator (i.e., student or user) interacts 108 with one or more simulation modes, such as simulation exercises. Interacting 108 includes performing one or more simulated exercises substantially similar to an OEM exercise for the non-simulated heavy equipment model. For example, the specific exercises that an OEM designates for training an operator on a “real world” machine are substantially simulated within the simulator. Further, the evaluation and criteria by which the operator is judged in the simulation substantially or exactly mimics the criteria used to evaluate “real world” operators of non-simulated machines or heavy equipment.

Examples of training exercises include walkaround, controls familiarization, bucket placement, “raking the green”, “over the moon”, loading & off loading the machine from a trailer, trenching, truck loading, bench loading, setting trench box and pipe, backfilling, production cycle, quick coupler and open training.

The walkaround exercise can utilize the machine (i.e., vehicle or heavy equipment) and review the proper pre-operation walkaround procedures. The user can start at the base of the machine and work their way through the different inspection points per section on the machine. The user can navigate between inspection sections using directional arrows, for example. The user can highlight the proper inspection point or have the inspection point highlighted by pointing at the name in a list. At each inspection point a question can be posed to the user relating to the part or inspection point. The user can have the ability to indicate whether the inspection point is faulty or passes inspection. The user can work their way around the machine from base to cab in an organized manner every time the exercise is run. The exercise is complete when all inspection points have been reviewed. The walkaround can be divided into Ground Level, Engine/Platform Level, and Cab Level inspections.

Before simulating operating tasks, pre-operation tasks can be simulated.

Examples of pre-operation tasks include control reset, startup procedures, safe machine operation, shutdown procedures, entering machine and exiting machine. Control reset checks include making sure all controls are in the proper position prior to starting the machine (e.g., on/off key position, hydraulic lock lever position, fine swing control on/off, etc.). A horn signal may be used to indicate all controls are set properly. A user cannot pass this check if controls are not set properly (regardless of horn activation).

The controls familiarization exercise can utilize the machine and review the basic control operations of the machine. The control review can be randomized so that the order is not always known by the user. During this exercise the simulation can display an icon/control image helper system in the lower left corner of the user view. The user can have a set amount of time to perform the requested action by the simulation, and after that time they can fail for not following instructions.

Startup procedures can be prompted by on-screen text or after the control reset exercise is completed. Examples of startup procedure checks include fastening seat belt and warming up machine. Safe machine operations exercise can include such actions carrying implements at a safe distance from the ground, avoiding terrain obstacles, filling containers to appropriate levels, engine speed, for example. Shutdown procedures exercise requires a user to park on a level surface, reduce engine speed, allow travel levers to return to correct position, swing cab to front of machine, lower implement, move hydraulic lockout control to correct position and other actions to ensure a safe shutdown and position the machine for a subsequently safe startup. Entering and exiting the machine exercise can include instruction on proper methods to mount and dismount the specific piece of equipment.

A warning system can be utilized and is designed to help inform the user of incorrect actions, unsafe practices, etc. so the user has a better understanding of proper machine operation and what is considered incorrect or unsafe. The warning system also helps the simulation keep the user on-track with the necessary exercise steps and procedures. If multiple warnings are present in the system, the most important problem can be shown first.

Audible cues and sounds are implemented during an initial safety walkaround, such as by correctly identifying a non-broken part, correctly identifying a broken part, incorrectly identifying a part as broke, incorrectly identifying a part as non-broken, opening compartment doors, removing and replacing fluid level dipsticks, extracting and retracting the machine seatbelt.

During the simulation there can be an “environment” sound being played. This can provide normal background sounds to a typical construction environment (wind, birds, machines/trucks driving, etc.). On top of the “environment” sound events occurring during the exercise can be linked to specific sounds. A few examples include operator entry, starting the machine, machine implement slams. Sounds can change during the exercise, such as when changing the engine speed control dial, putting load on the engine, moving the machine implements, etc.

The bucket placement exercise can utilize the machine and can cover basic movements of the stick/boom/bucket combination to line-up with a pre-defined bucket location (indicated by a frame guide, for example). The frame guide can be a wire frame guide that models the proper position of an implement or portion of a vehicle or piece of equipment. The exercise can show the pre-defined bucket wire frame model and bucket alignment indicator in both practice and exam mode. The exercise can instruct the user to make control movements that allow the machine to raise the bucket off the ground and into the correct pre-defined bucket location. The machine bucket can be empty during the exercise.

The “raking the green” exercise can utilize the machine and can cover basic movements of a stick/boom/bucket combination to utilize the tips of the bucket in a raking fashion through material (e.g., dirt). The exercise can show the pre-defined raking trajectory path in practice and exam mode. The exercise can instruct the user to make control movements that allow the machine to utilize the bucket as a rake to remove the top portion of material to demonstrate real-world applications of the exercise. The machine bucket can be empty during the exercise.

The “over the moon” exercise can utilize the machine and an articulated vehicle, such as a truck. The exercise can cover basic arch movements of a stick/boom/bucket combination through a real-world application. The exercise can show arch helpers in both practice and exam modes. The exercise can guide the user to make control movements that allow the machine to raise the bucket off the ground and over the articulated truck bed in an arch to the other side and back on the ground. The machine bucket can be empty during the exercise.

The loading and off-loading exercise can utilize the machine and a transport truck/trailer, such as a “low boy” trailer. The exercise can start with the machine loaded and ready to be unloaded from the “low-boy” trailer. The user can unload the machine properly, following all safety procedures outlined by the equipment manufacturer and any safety organizations.

A trenching exercise can utilize the machine and can review the basic operations for trenching and proper spoil placement at the side of the trench. The user can dig a trench, following all safety procedures outlined by the equipment manufacturer and any safety organizations. The digging area can be marked properly when the exercise starts.

The user can dig a vertical trench, extending out from the existing trench. The trench can be designed in a way that the user must work around an existing pipeline.

A truck loading exercise can utilize the machine and an articulated vehicle to review the basic operations for truck loading using the “over the rail” technique. The user can be loading a truck from ground level, following all safety procedures outlined by the equipment manufacturer and any safety organizations. The digging area can be directly in front of the user, and once the user has a bucket load they can properly spot the truck for loading (the truck can maneuver to the proper location for “over the rail” loading). Once the user has loaded the truck they can send it away and the user can load the truck to the defined loading capacity as set in Instruction module. Once the user has filled the truck to capacity they can signal for it to haul

A bench loading exercise can utilize the machine and an articulated vehicle to review the basic operations for truck loading from a bench. Optionally, a machine/user may start on the bench instead of having to tram up the bench. The user can then be loading a truck from the bench (placing the base of the machine at the top level of the bed rails on the truck), following all safety procedures outlined by the equipment manufacturer and any safety organizations. The digging area can be directly in front of the user, and once the user has a bucket load they can properly spot the truck for loading (the truck can maneuver to the proper location for “over the rail” loading). Once the user has loaded the truck they can send it away and the user can load the truck to the defined loading capacity as set in Instruction module. Once the user has filled the truck to capacity they can signal for it to haul thee load away and then they can safely shutdown the machine.

A setting trench box and pipe exercise can utilize the machine to review the basic operations for setting a trench box and pipe. The user can start with a complete trench ready for the trench box to be placed. The exercise can start with the machine and tram to the proper location for setting the trench box. Once there the user can detach the bucket implement and then attach the trench box. The user can lower the trench box into the trench, while demonstrating safe operating procedures. Once lowered the user can then attach the pipe and lower it into the trench, while demonstrating safe operating procedures. Once lowered the user can then move the machine to a location where it can be safely shutdown.

A backfilling exercise can utilize the machine and an articulated vehicle to review the basic operations for backfilling a trench. The user can start with the trench cut and pipe positioned correctly for final backfilling. The user can tram to the proper location for backfilling. The user can go through the basic operations for backfilling a trench, and they can completely fill the trench as marked in the simulation (spoil will be placed to the right of the trench). Once completely filled the user can then move the machine to a location where it can be safely shutdown.

A production cycle exercise can utilize the machine to review a full production cycle, building on all the task skills reviewed/learned in the previous exercises. The user can start by entering the machine on the “low-boy” trailer; they can unload the machine and then move to the trenching area. The user can then dig a trench, set the trench box and pipe, and backfill the trench. After backfilling the trench the user can load the machine back onto the “low-boy” trailer to complete the full production cycle.

A quick coupler exercise can utilize the machine to review the basic operations for changing tools using the quick coupler feature on the machine. The user can be stepped through detaching and attaching the work tool using the center lock quick coupler.

An artificial intelligence (AI) component can be used to simulate on-site directions from a co-worker. The AI component is shown on the user interface as a worker giving hand signals to the operator.

The Camera Helper System is designed to give the user a first person view of specific areas within the simulation that require another view to get the full sense of depth. The Camera Helper System also shows how the Quick Coupler control functions (as far as locking and unlocking the bucket), as well as giving the user a better view of the AI guide when needed. The placement of the Camera Helper can be set in code and cannot be modified through a configuration setting. The placement of the Camera Helper View can be in the lower right corner of the simulation view. This allows easy viewing and keeps the users view of the environment uninterrupted.

When in exercises where the user needs to load a truck, a truck helper camera can be displayed so that the user can easily see where their bucket/stick combination is positioned relative to the truck bed.

During select exercises, a helper camera view can be enabled on one or more of the displays. When the user spots a truck for loading (in both the Truck Loading and Bench Loading exercises, for example) the helper camera system can be enabled

When in exercises where the user needs to detach and attach machine implements a helper camera can be displayed so that the user can easily see where their coupler mechanism is located with respect to the implement they are trying to attach. When detaching implements the camera view can show the coupler joint with the implement and how the mechanism unlocks when the user sends certain commands to the machine.

When in exercises where the user needs to be assisted by another operator within the environment to help with object placement, the camera can be displayed so that the user can easily see the signaling operator (AI guide) as they guide the object safely to the final placement location. This camera view can be displayed in both practice and exam mode to assist with the user viewing the AI guide's hand signals.

After interacting with simulation modules 108, the results are then transferred 112 to the instruction module and output 114 onscreen or printed. Results can be output 114 in real-time to instructor, student or both. The results can be transferred 112 within the simulator hardware or via a wireless or cellular signal, for example. The instruction module includes options for sorting and viewing the results. The simulator methods and system emphasizes safety while operating the equipment to increase the student's knowledge level and awareness of jobsite safety. The simulator tracks numerous safety violations during training lessons. Anytime a safety violation is detected, a message can be displayed indicating the type of violation and any other relevant information. The system provides real-time feedback to the student when mistakes are made and potential hazards are encountered.

When a user operates the machine through the entire exercise and completes the necessary tasks the simulation or instructor can pass the user. The score in each lesson can be generated based on time, productivity, equipment damage (number of contacts with external objects), and exercise success. The simulator tracks/reports numerous metrics and generates student scores based on performance measures being recorded with the “final score” for a lesson being expressed in terms of exercise success as well as reporting of performance measures and metrics.

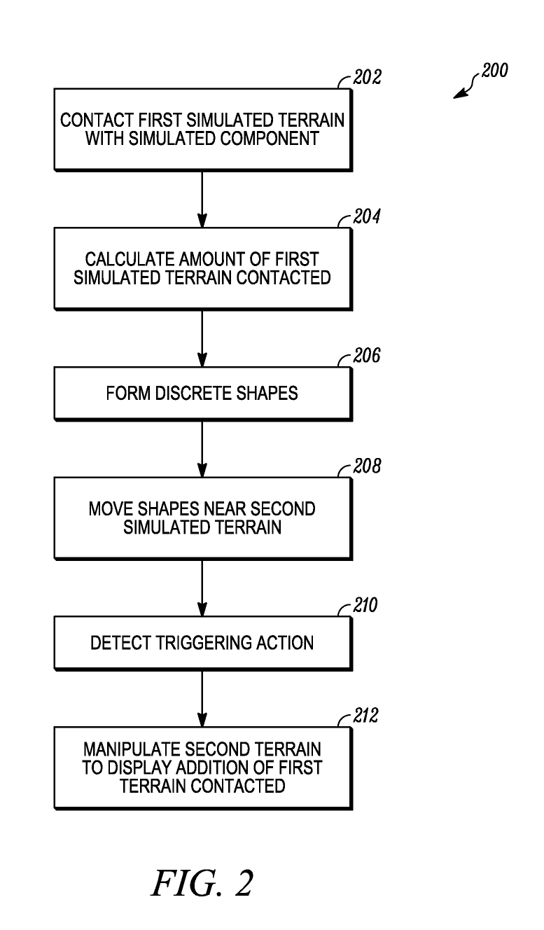

Referring to FIG. 2, a block flow diagram 200 of a method of simulating terrain is shown, according to some embodiment. A first simulated terrain can be contacted 202 with a simulated component. The amount of first simulated terrain contacted is then calculated 204. Discrete shapes of the first simulated terrain contacted are formed 206. The shapes can then be moved 208 within a simulation to within proximity of a second simulated terrain. One or more triggering actions of the first simulated terrain can be detected 210 in respect to the second simulated terrain. The second simulated terrain can be manipulated 212 to visually display an addition of the first simulated terrain contacted.

The first simulated terrain can be editable terrain, such as earth, debris, or other material that may interact with a simulated piece of machinery or equipment. The simulated component, such as an implement of heavy equipment, contacts 202 the first simulated terrain. The implement can be a bucket, blade or other attachment on a vehicle or heavy equipment. Contacting 202 can be digging, pushing, scraping, breaking, grabbing or other motion in which the simulated component and first simulated terrain interact.

Once the first simulated terrain is contacted 202, an amount of first simulated terrain is calculated 204. For example, if a simulated bucket digs a portion of simulated earth from the first simulated terrain, a calculation is made as to the amount dug or interacted with. The calculation may be a volumetric calculation, for example. The first simulated terrain contacted can be formed into discrete shapes 206, such as spheres or irregular shapes that visually represent the terrain being interacted with. The size and number of shapes formed 206 may affect the performance and processing needs of the simulation.

Once the shapes are formed 206, such as dirt clods in a bucket, they can be moved 208 within the simulation to near or within proximity to a second simulated terrain. The second simulated terrain can be positioned in a layer underneath the visual layer of the desired or possible receiving locations (i.e., simulated receiving component) of the first simulated terrain contacted. For example, the second simulated terrain can be positioned underneath the bed of truck or trailer in which the operator of the simulator is directed to place the material or first simulated terrain contacted. The simulated receiving component or receiving location can be one or more of a truck bed, dumpster, trench and trailer.

One or more triggering actions of the first simulated terrain can be detected 210 independently or in respect to the second simulated terrain. For example, the triggering action can be one or more orientations of the first simulated terrain or the simulated component interacting with the terrain, independently or in respect to the position of the second simulated terrain. The triggering action can independently be a certain simulated velocity of the first simulated terrain contacted or simulated component. One the triggering action is detected 210, the first terrain contacted interacts with the second simulated terrain. For example, at a certain velocity or orientation, the bucket can release the simulated earth into a simulated trailer bed. The second simulated terrain, positioned underneath or integrated with the visual display of the trailer bed then responds or is manipulated 212 to visually display the addition of such material into the bed. The volume or calculated first simulated terrain can be meshed with second simulated terrain and visually display local peaks, piles or generally raise the height of the second simulated terrain to indicate the addition of the material to that simulated location (i.e., the second simulated terrain). The spheres of first simulated terrain contacted are optionally destroyed or smoothed out, according to visual preference within the simulation.

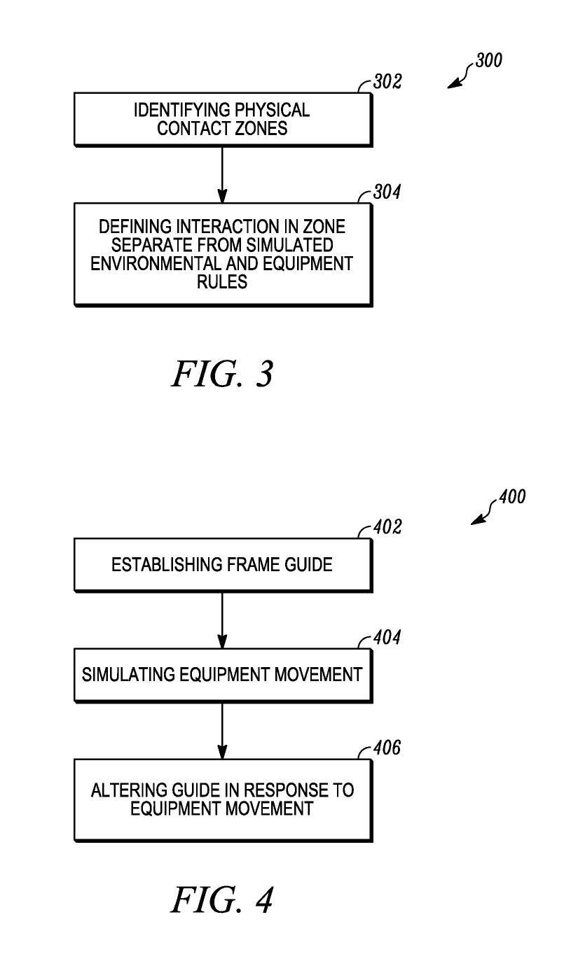

Referring to FIG. 3, a block flow diagram 300 of a method of simulating a physical interaction in a simulator is shown, according to some embodiments. Simulated physical contact zones between two or more simulated objects can be identified 302. One or more interactions in the contact zones can be defined 304 separately from the simulated environmental or equipment object rules. For example, when the environment (i.e., dirt or ground) and a piece of equipment (e.g., bucket) interact, the physical rules for their interaction are defined similar to many types of collisions found written into the software package. An example of physical contact zone includes regions in which objects in the environment are expected to collide or interact. In order to smooth the visual look of the interaction, reduce the resource drain to calculate the physics of the interaction and overall optimize the interaction, the specific zone can be isolated and defined (by rules separate from other interactions in the environment).

In order for equipment interactions to display realistically without significantly affecting performance, virtual contact zones or joints can be created between components. For example, once a component moves into a physical contact zone, real time physics of movement is eliminated or altered and a separate rules system is enacted, such as removing harsh collisions between objects. Such a system allows for smoother, more realistic physical interactions between components on screen, without dragging performance.

Referring to FIG. 4, a block flow diagram 400 of a method of training an operator of a machine is shown, according to some embodiments. A frame guide for an exercise can be established or formed 402. Movement of one or more pieces of equipment or vehicles can be simulated 404. The frame guide can be altered 406 in response to the movement. The frame guide may be one or more wire frame models showing the proper placement of implements, vehicles or portions of equipment during exercises. As the user moves the equipment towards the proper position, the alteration of the frame guide may include change color, opacity, size, or other visual cue.

The frame guide can be utilized to give the user a visual sense of where their current location of the implement is in relation to the wire frame model they are trying to line up with. The system can calculate a value based on the position (x, y, z) and orientation (yaw, pitch, roll) of the current implement location compared to the pre-defined location the user is trying to align with. The calculated value can then be translated to a color shader, which can cause the wire frame model to change colors that can help guide the user to proper implement alignment. Examples of features that can utilize the wire frame helper include bucket, stick, boom, tracks, trench box and pipe. The wire frame guide can indicate depth of field to provide the user with depth perception while guiding a simulated component. The depth of field indicator can be separate from other indicators.

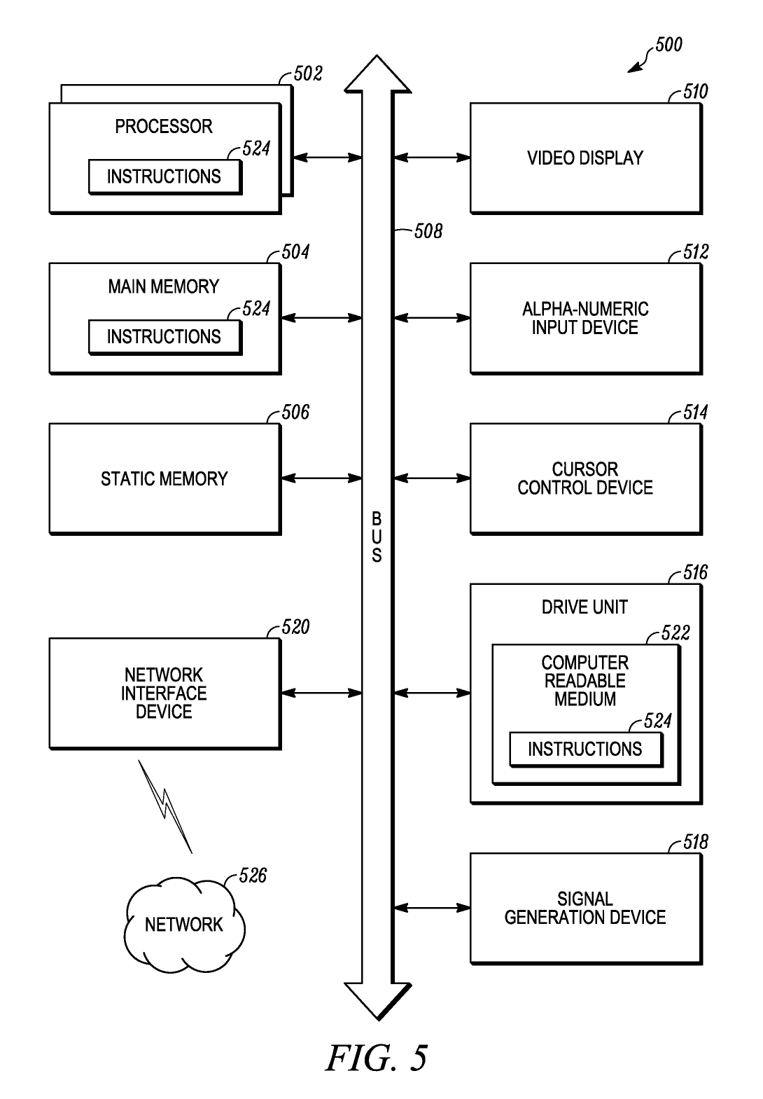

FIG. 5 shows a diagrammatic representation of machine in the example form of a computer system 500 within which a set of instructions may be executed causing the machine to perform any one or more of the methods, processes, operations, or methodologies discussed herein. The provider 506 and/or the user relationship management provider 512 may operate on or more computer systems 500. The client machine 502 may include the functionality of one or more computer systems 500.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU) a graphics processing unit (GPU) or both), a main memory 504 and a static memory 506, which communicate with each other via a bus 508. The computer system 500 may further include a video display unit 510 (e.g., a liquid crystal display (LCD) or a cathode ray tube (CRT)). The computer system 500 also includes an alphanumeric input device 512 (e.g., a keyboard), a cursor control device 514 (e.g., a mouse), a drive unit 516, a signal generation device 518 (e.g., a speaker) and a network interface device 520.

The drive unit 516 includes a machine-readable medium 522 on which is stored one or more sets of instructions (e.g., software 524) embodying any one or more of the methodologies or functions described herein. The software 524 may also reside, completely or at least partially, within the main memory 504 and/or within the processor 502 during execution thereof by the computer system 500, the main memory 504 and the processor 502 also constituting machine-readable media.

The software 524 may further be transmitted or received over a network 526 via the network interface device 520.

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the embodiments of the present invention. The term “machine-readable medium” shall accordingly be taken to include, but not be limited to, solid-state memories, optical and magnetic media, and carrier wave signals.

Certain systems, apparatus, applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules be implemented as hardware circuitry, optical components, single or multi-processor circuits, memory circuits, software program modules and objects, firmware, and combinations thereof, as appropriate for particular implementations of various embodiments.

The Abstract of the Disclosure is provided to comply with 37 C.F.R. §1.72(b), requiring an abstract that can allow the reader to quickly ascertain the nature of the technical disclosure. It is submitted with the understanding that it can not be used to interpret or limit the scope or meaning of the claims. All documents referred to herein are hereby incorporated by reference for any purpose. However, if any such document conflicts with the present application, the present application controls. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method for training an operator of heavy equipment, comprising:
interacting with a simulation mode of a heavy equipment model simulator; and
evaluating an operator using criteria substantially similar to an original equipment manufacturer (OEM) criteria for a non-simulated heavy equipment model;
wherein interacting includes performing one or more simulated exercises substantially similar to an OEM exercise for the non-simulated heavy equipment model.

2. The method of claim 1, before interacting with a simulation mode, one or more of initiating an instruction module, initiating a simulation module for controlling a simulated machine and selecting an instruction mode.

3. The method of claim 1, after evaluating, one or more of compiling results, transferring results to instruction module and outputting results.

4. The method of claim 2, wherein initiating an instruction module is performed by an operator.

5. The method of claim 2, wherein initiating an instruction module is performed by an instructor.

6. The method of claim 5, wherein the initiating comprise the instructor utilizing a remote input device.

7. The method of claim 6, wherein the remote input device comprises a cell phone, tablet computer, laptop computer or personal digital assistant (PDA).

8. The method of claim 1, wherein interacting with a simulation mode comprises interacting with one or more of an operator entry exercise, controlled reset exercise, startup exercise, shut down exercise or operational exercise.

9. The method of claim 3, wherein outputting results comprises producing a visual display, a printed paper or both.

10. A method of simulating terrain, comprising:
contacting a first simulated terrain with a simulated component;
calculating an amount of first simulated terrain contacted;
forming discrete shapes of the first simulated terrain contacted;
moving the shapes within a simulation to within proximity of a second simulated terrain;
detecting one or more triggering actions of the first simulated terrain contacted in respect to the second simulated terrain; and
manipulating the second simulated terrain to visually display an addition of the first simulated terrain contacted.

11. The method of claim 10, wherein contacting a first simulated terrain comprises simulated earth.

12. The method of claim 10, wherein the simulated component comprises a heavy equipment implement.

13. The method of claim 12, wherein the implement comprises a bucket or blade.

14. The method of claim 10, wherein calculating an amount of first simulated terrain contacted comprises calculating a volume of first simulated terrain contacted.

15. The method of claim 10, wherein forming discrete shapes comprises displaying spheres of earth in a simulation.

16. The method of claim 15, wherein moving the shapes within a simulation comprises visually displaying a heavy equipment implement moving spheres of earth.

17. The method of claim 10, wherein the second simulated terrain comprises a layer underneath a simulated receiving component.

18. The method of claim 17, wherein the simulated receiving component comprises one or more of a truck bed, trench and trailer.

19. The method of claim 10, wherein manipulating the second simulated terrain comprising meshing the volume of the first simulated terrain contacted with the second simulated terrain.

20. The method of claim 10, wherein the one or more triggered actions comprise one or more of an orientation and velocity.

21. A method of simulating a physical interaction in a simulator, comprising:
identifying simulated physical contact zones between two or more simulated objects; and
defining one or more interactions in the contact zones separate from simulated environmental or equipment object rules.

22. A machine-readable medium comprising instructions, which when implemented by one or more processors perform the following operations:
interacting with a simulation mode of a heavy equipment model simulator; and
evaluating an operator using criteria substantially similar to an original equipment manufacturer (OEM) criteria for a non-simulated heavy equipment model;
wherein interacting includes performing one or more simulated exercises substantially similar to an OEM exercise for the non-simulated heavy equipment model.
